(19) United States
(12) Patent Application Publication
(10) Pub. No.: US 2004/0119376 A1
(43) Pub. Date: Jun. 24, 2004

(54) Bidirectional and vertical motion actuator and method for manufacturing the same

(76) Inventors: Bruce C. S. Chou, Hsin Chu (TW); Chen-Chih Fan, Chu Pei City (TW); Wei-Ting Lin, Taipei City (TW); Ming-Lin Tsai, Taipei City (TW); Wei-Leun Fang, Hsinchu City (TW); Chingfu Tsou, Hou Li Hsiang (TW)

Correspondence Address: BIRCH STEWART KOLASCH & BIRCH, PO BOX 747, FALLS CHURCH, VA, 22040-0747, US

(21) Appl. No.: 10/656,223

(22) Filed: Sep. 8, 2003

(30) Foreign Application Priority Data
Sep. 9, 2002 (TW) 91120405

(51) Int. Cl. H02N 1/00

(52) U.S. Cl. 310/309

(57) ABSTRACT

A method for manufacturing a bidirectionally vertical motion actuator includes the steps of: providing a silicon-on-insulator (SOI) wafer, which comprises a first silicon wafer, an insulation layer on a top surface of the first silicon wafer, and a second silicon wafer; forming a dielectric layer on the SOI wafer by way of deposition; depositing a conductive layer on the dielectric layer; etching the conductive layer, the dielectric layer and the second silicon wafer simultaneously to form a proper top trench; and forming an anisotropic etching groove on a backside of the SOI wafer. A bidirectionally vertical motion actuator formed using the method is also disclosed.

### BACKGROUND OF THE INVENTION

1. Field of the Invention

The invention relates to an electrostatic actuator, and more particularly to a vertical comb drive actuator movable in two directions, and applications in micro optical passive devices such as a phase modulator, a tunable filter, a variable optical attenuator, an optical switch, a torsion mirror, and the like.

2. Description of the Related Art

In the development of Micro-Electro-Mechanical-System technology, actuators may be used in various applications, and especially in optical active/passive devices such as a phase modulator, an optical switch, a variable optical attenuator, an tunable filter, and tunable laser, a scanning mirror, and the like. The typical actuation principle may be basically divided into an electrostatic type, an electromagnetic type, a thermal and piezoelectric type, wherein the electrostatic actuator is the main design according to the simple integration of the manufacturing processes and the facility of controlling.

The moving effects of the traditional electrostatic actuator are obtained by controlling the attraction force of the electric field between two conductors, and depend on the magnitude of the electric field and the micro-structure design. The main micro-structure is designed using parallel plate electrodes or interdigital electrodes. However, the critical feature of the parallel plate electrodes is nonlinear motion, and the allowed movable distance thereof merely equals to one third of the initial gap, or otherwise the pull-in phenomenon may occur. If the required moving displacement is greater, a greater initial gap has to be defined, thereby causing the driving voltage to be too high. Although the design of the interdigital electrodes may cause approximately linear motion, the motion is limited to only the x-y plane motion and cannot be applied to the upward and downward vertical motion along the z axis.

The invention solves the above-mentioned problems by providing a bidirectional and vertical motion actuator, wherein the vertical moving displacement may be precisely controlled up to the nanometer level.

### SUMMARY OF THE INVENTION

An object of the invention is to provide an electrostatic actuator capable of moving linearly on a horizontal plane and vertically on the vertical plane, and a method for manufacturing the same.

Another object of the invention is to provide a vertical comb drive actuator which may move bidirectionally and vertically. The two in-plan supporting beams are perpendicular to each other so as to prevent a suspended membrane from moving in the x-y axis due to unbalanced electrostatic forces, and to restrict the suspended membrane to move in the vertical direction.

Still another object of the invention is to provide an actuator including interdigital electrodes to solve the problem of the displacement limitation of the traditional parallel-plate actuator, wherein the limitation only equals to one third of the maximum displacement, and the relationship between the driving voltage and the displacement of the actuator is approximately linear.

Yet still another object of the invention is to provide a vertical comb drive actuator, which may move bidirectionally and vertically and may be applied to a micro optical passive device such as a phase modulator. Also, the actuator may be combined with a fixed reflective mirror to form a tunable filter, or even with a lever to be a variable optical attenuator or an optical switch. The actuator may precisely control the moving displacement up to the nanometer level along the vertical direction.

To achieve the above-mentioned objects, the invention provides a bidirectionally vertical motion actuator that is manufactured by depositing a dielectric layer and a conductive layer on a silicon-on-insulator (SOI) wafer, etching the conductive layer, the dielectric layer and the silicon-on-insulator (SOI) wafer simultaneously to form a proper top trench, and forming a membrane structure by anisotropic backside etching.

According to one aspect of the invention, a bidirectionally vertical motion actuator includes a substrate, a floating structure located above the substrate and comprising a suspended membrane and at least one supporting beam extending outwardly from a boundary of the suspended membrane in a direction substantially parallel to the suspended membrane, and at least one fixed electrode structure, which is insulated from the floating structure and is formed on a lateral side of the floating structure and fixed onto the substrate.

According to another aspect of the invention, a vertical comb drive actuator that may move bidirectionally is formed with at least one suspended interdigital electrode extending outwardly from a lateral side of the membrane structure, and at least one fixed interdigital electrode staggered with the at least one suspended interdigital electrode at a lateral side facing the membrane structure.

The bidirectionally vertical motion actuator or vertical comb drive actuator of the invention may be combined with a fixed mirror to form a phase modulator, and with a lever to form a light intensity controller.

### BRIEF DESCRIPTION OF THE DRAWINGS

FIG. 1 is a structural, cross-sectional view showing a bidirectionally vertical motion actuator of the invention.

FIG. 2 is a schematic illustration showing the operation principle of the bidirectionally vertical motion actuator of the invention.

FIG. 3 is a schematic illustration showing the operation principle of the bidirectionally vertical motion actuator of the invention.

FIGS. 4A to 4D are structural, cross-sections in each step for manufacturing the bidirectionally vertical motion actuator of the invention.

FIG. 5 is a structural top view showing a vertical comb drive actuator of the invention.

FIG. 6 is a top view showing a vertical comb drive actuator according to another embodiment of the invention.

FIG. 7 is a graph showing the relationship between the displacement of the suspended membrane and the driving voltage of the invention.

FIG. 8 shows an application embodiment of the bidirectionally vertical motion actuator of the invention, which is applied to a phase modulator.

FIG. 9 shows another application embodiment of the invention.

FIG. 10 shows still another application embodiment of the invention.

FIG. 11 shows a schematic illustration of one application of the bidirectionally vertical motion actuator of the invention to a torsion mirror.

FIG. 12 shows a schematic illustration of another application of the bidirectionally vertical motion actuator of the invention to a torsion mirror.

### DETAILED DESCRIPTION OF THE INVENTION

The invention provides a bidirectionally vertical motion actuator which can linear and precisely control and achieve the displacement of degree of nanometer. The actuator may serve as an optical phase or intensity modulator.

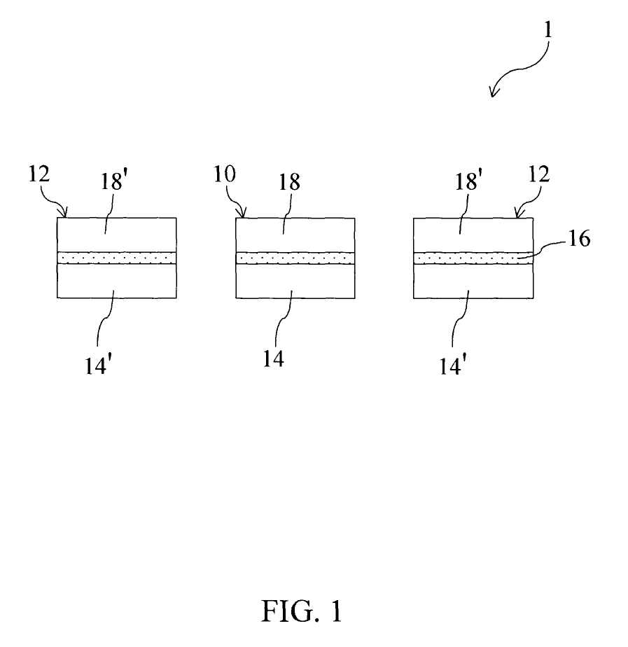

FIG. 1 is a cross-section view showing a bidirectionally vertical motion actuator of the invention. As shown in FIG. 1, the bidirectionally vertical motion actuator 1 includes a substrate (not shown in this figure) and a suspended membrane 10 located above the substrate. The suspended membrane 10 has four corners supported by four pairs of supporting beams (not shown) extending outwardly from the boundary of the suspended membrane 10 in directions substantially parallel to the suspended membrane 10, wherein the supporting beams in each pair are substantially perpendicular to each other. The supporting beams are used to support the suspended membrane 10 above the substrate to form a floating structure. A fixed electrode structure 12 is arranged beside each of the four lateral sides of the suspended membrane 10 with a small gap therebetween. The fixed electrode structures 12 are insulated from the suspended membrane 10 and are fixed onto the substrate. The suspended membrane 10 and the fixed electrode structure 12 have the same material and structure and include first conductive layers 14 and 14′, dielectric layers 16 on top surfaces of the first conductive layers 14 and 14′, and second conductive layers 18 and 18′ on top surfaces of the dielectric layers 16, respectively. Thus, each of the suspended membrane 10 and the fixed electrode structure 12 forms a sandwich structure, and the first conductive layer 14′ of the fixed electrode structure 12 is fixed onto the top surface of the substrate.

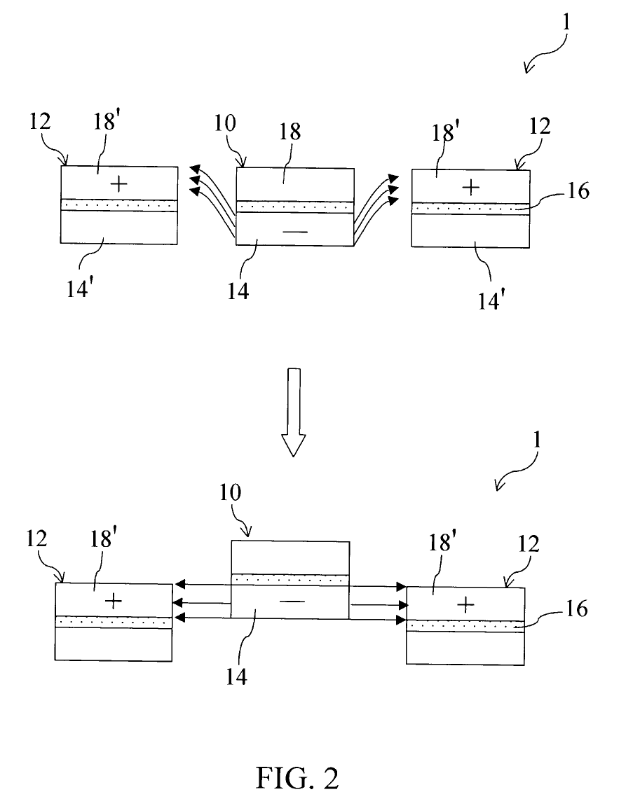

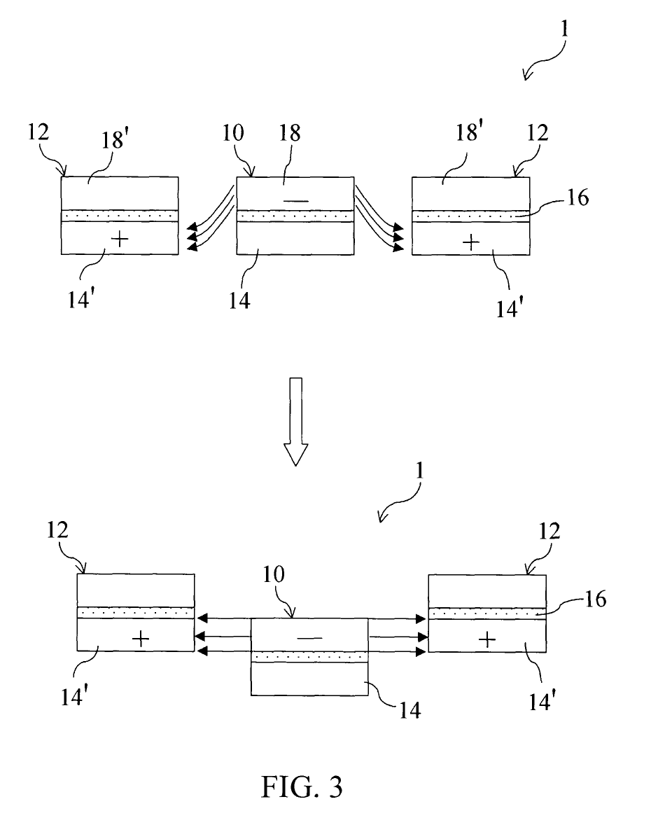

The operation principle of the bidirectionally vertical motion actuator 1 will be described with reference to FIGS. 2 and 3. As shown in FIG. 2, when a voltage difference is applied between the first conductive layer 14 of the suspended membrane 10 and the second conductive layer 18′ of the fixed electrode structure 12, an electric field having force directions as indicated by the arrows is generated to provide a force to lift the suspended membrane 10 until the directions of electric lines of forces at two sides of the suspended membrane 10 are parallel to each other. On the contrary, as shown in FIG. 3, when a reverse voltage difference is applied between the second conductive layer 18 of the suspended membrane 10 and the first conductive layer 14′ of the fixed electrode structure 12, an electric field having force directions as indicated by the arrows is generated to provide a force to lower the suspended membrane 10 until the directions of electric lines of forces at two sides of the suspended membrane 10 are parallel to each other. It is possible to control the operations by providing a switch between the suspended membrane 10 and the fixed electrode structure 12.

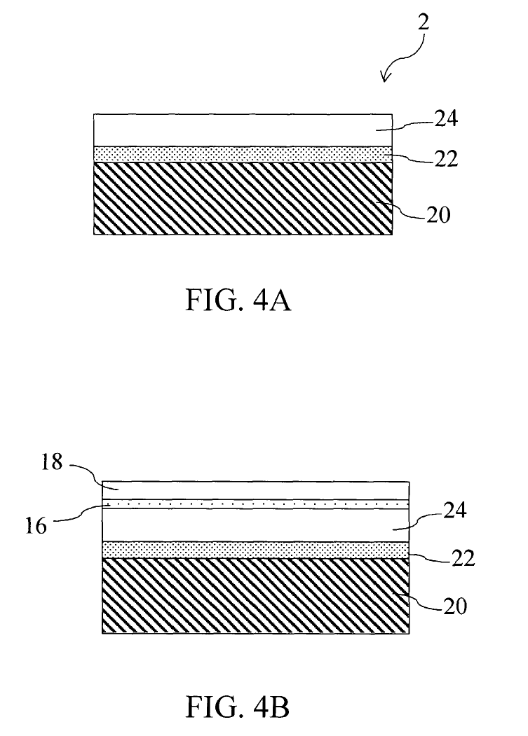

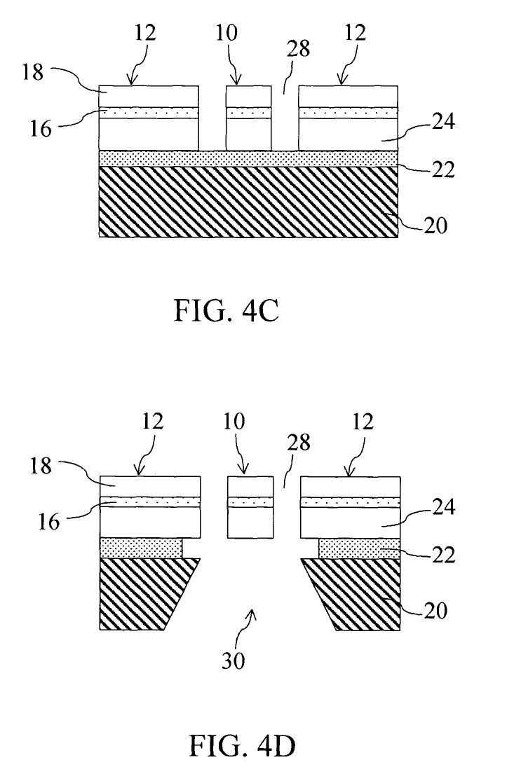

The manufacturing method of the bidirectionally vertical motion actuator 1 of FIG. 1 will be described with reference to FIG. 4. FIGS. 4A to 4D are structural, cross-sections in each step for manufacturing the bidirectionally vertical motion actuator of the invention. The method includes the following steps. First, a silicon-on-insulator (SOI) wafer 2 is provided, as shown in FIG. 4A. The SOI wafer 2 includes a handle silicon wafer 20, a silicon oxide insulation layer 22, and a device silicon wafer 24. The device silicon wafer 24 is a good conductor having low resistivity with thickness of 5 to 30 microns. Next, a dielectric layer 16 and a second conductive layer 18 on an top surface of the dielectric layer 16 are formed on the device silicon wafer 24 of the SOI wafer 2 by way of deposition, as shown in FIG. 4B. Then, as shown in FIG. 4C, the second conductive layer 18, the dielectric layer 16 and the device silicon wafer 24 are simultaneously etched by way of deep silicon etching to form a proper trench 28. The trench 28 may be a ring-shaped trench, a rectangular ring-shaped trench or a line-shaped trench according to the design and manufacture requirements. In this embodiment, the trench 28 is a rectangular ring-shaped trench vertically penetrating through the second conductive layer 18, the dielectric layer 16 and the device silicon wafer 24, and the suspended membrane 10 and the fixed electrode structure 12 are formed by the division of the rectangular ring-shaped trench. The second conductive layer 18 is etched to form the trench 28 to divide it into the second conductive layers 18 and 18′ of FIG. 1, while the device silicon wafer 24 is etched to form the trench 28 to divide it into the first conductive layers 14 and 14′ of FIG. 1. Finally, as shown in FIG. 4D, an anisotropic etching groove 30, which penetrates through the handle silicon wafer 20 and the silicon oxide insulation layer 22 from the backside of the SOI wafer 2 and communicates with the trench 28 is formed.

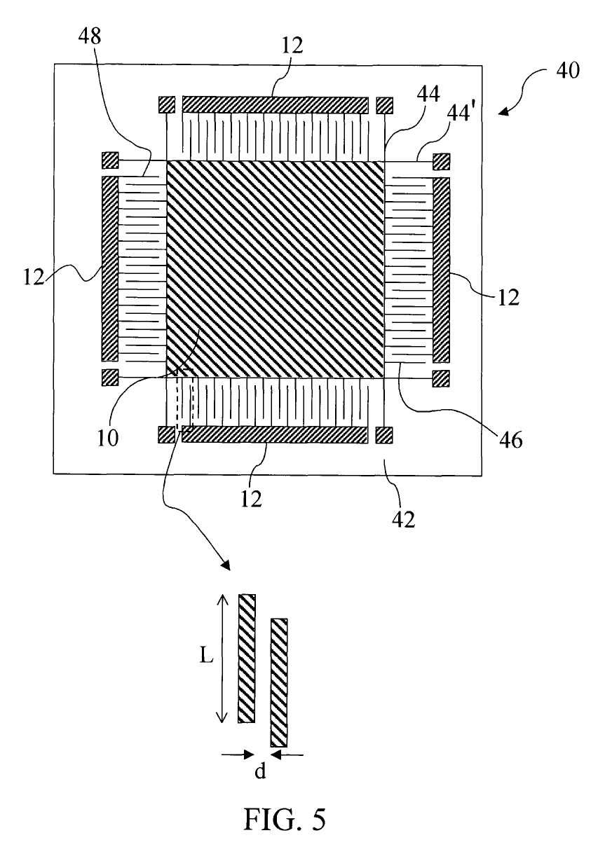

In order to form a vertical comb drive actuator that may move bidirectionally and vertically, the materials and processes of FIG. 4 may be used. In addition, please refer to FIG. 5, which is a structural top view showing a vertical comb drive actuator 40 according to another embodiment of the invention. The actuator 40 includes a substrate 42 and a suspended membrane 10 located above the substrate 42. The suspended membrane 10 has four corners supported by four pairs of supporting beams 44 and 44′ so as to suspend the suspended membrane 10 above the substrate 42. Suspended interdigital electrodes 46 extend outwardly from each of the four sides of the suspended membrane 10. A set of fixed electrode structures 12 is arranged around the suspended membrane 10 with a small gap therebetween. The fixed electrode structures 12 are insulated from the suspended membrane 10, and each fixed electrode structure 12 is fixed onto the substrate 42. The lateral side of each fixed electrode structure 12 is formed with fixed interdigital electrodes 48, which are staggered with the suspended interdigital electrodes 46 and towards the suspended membrane 10. The suspended interdigital electrodes 46 and the fixed interdigital electrodes 48 are overlapped and staggered to form a vertically interdigital electrode structure.

The suspended interdigital electrodes 46 and the fixed interdigital electrodes 48 have a length of L, and a gap of d, and all of the interdigital electrodes 46 and 48 have the same sandwich structure as the suspended membrane 10.

The suspended membrane 10 and the fixed electrode structure 12 of the vertical comb drive actuator 40 have the same material and structure, which is the same as that of FIG. 1. Thus, in the top view of FIG. 5, the suspended membrane 10 and the fixed electrode structure 12 includes the second conductive layers 18 and 18′, the dielectric layers 16 on the bottom surfaces of the second conductive layers 18 and 18′, and the first conductive layer 14 and 14′ on the bottom surfaces of the dielectric layers 16, respectively.

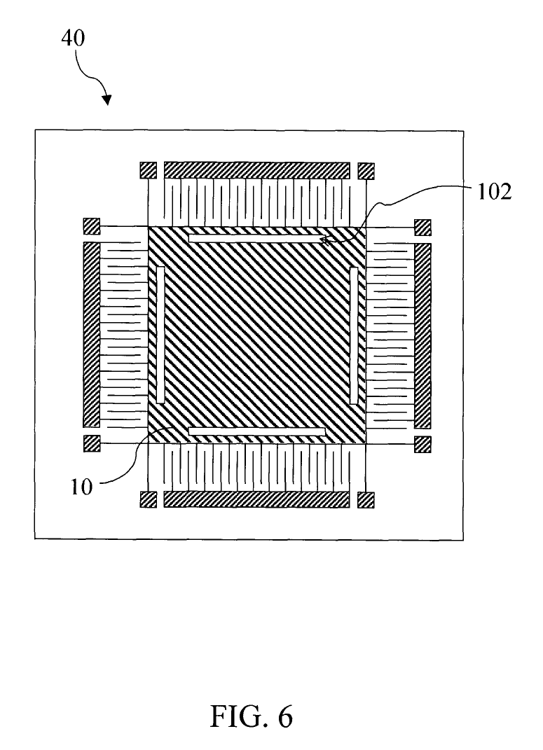

FIG. 6 is a top view showing the vertical comb drive actuator 40 according to another embodiment of the invention. As shown in FIG. 6, four slits 102 penetrating through the suspended membrane 10 are further formed in the structure of FIG. 5 so that a smoother membrane structure may be provided.

The vertical comb drive actuator 40 that may move bidirectionally and vertically as shown in FIG. 5 has the following advantages. First, the supporting beams 44 and 44′ perpendicular to each other may avoid the shift of the membrane on the x-y plane of the electrodes around the suspended membrane 10, which is caused by unbalanced electrostatic forces owing to manufacturing differences, thereby restricting the suspended membrane 10 to move in vertical directions. Second, the manufacturing processes and structure designs of the suspended interdigital electrode 46 and the fixed interdigital electrode 48 are quite simple, and the design of the interdigital electrode has the effect of uniformly applying forces to the suspended membrane 10 to keep the suspended membrane 10 at good parallelism when it moves up and down, which is quite important for the suspended membrane 10 to be applied to an optical phase or intensity modulator. Third, the design of the vertically interdigital electrodes is free from the restriction of the maximum displacement, which equals to only one third of that of the traditional parallel-plate actuator. In addition, the relationship between the driving voltage and displacement is quite linear, so the invention has a lot of advantages.

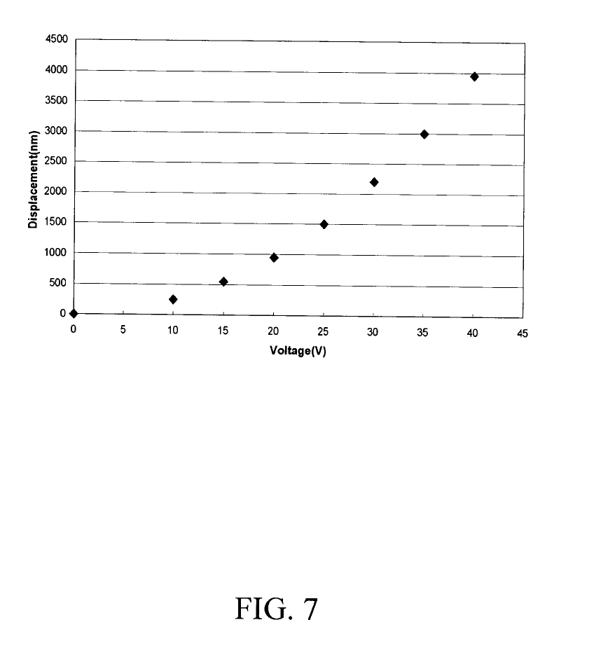

In order to describe the superiority of the invention, please refer to FIG. 7, which shows the data analysis between the driving voltage and the displacement of the suspended membrane 10. The data is obtained by testing a sample structure including a suspended membrane 10 with area of 1.5 mm*1.5 mm. Each of the suspended interdigital electrodes 46 and fixed interdigital electrodes 48 has a length L of 200 microns, and a gap d of 2 microns. The supporting beams 44 and 44′ are 500 microns in length and 15 microns in width. The graph of the upward displacements of the suspended membrane 10 caused by the electric field is depicted in this figure. As shown in the graph, when the electric field 20 (V), the displacement of the suspended membrane 10 approximates 1 microns, and the relationship between the voltage and the displacement is approximately linear.

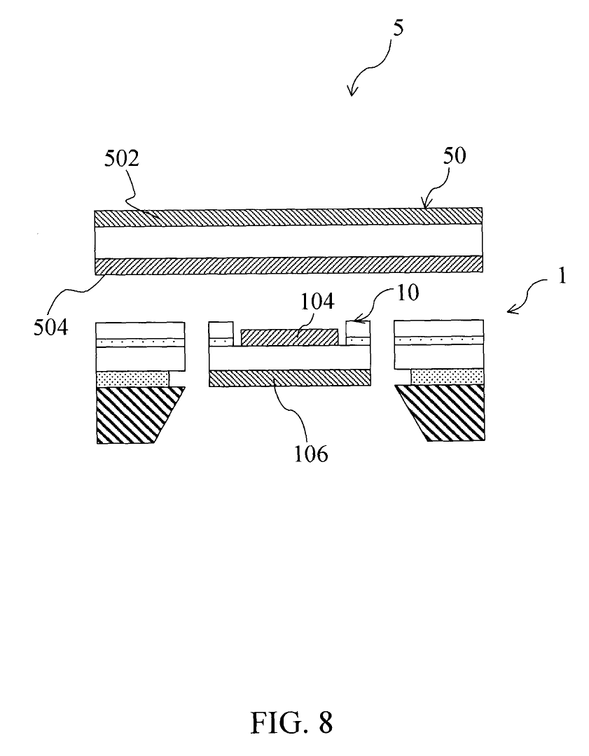

FIG. 8 shows an application embodiment of the bidirectionally vertical motion actuator 1 of the invention, which is applied to an optical phase modulator, such as a Fabry-Perot (FP) interferometer. In this embodiment, an optical phase modulator 5 includes a fixed mirror 50 having a top surface formed with an anti-reflective optical film 502 and a bottom surface formed with a high reflective optical film 504. The bidirectionally vertical motion actuator 1 of the invention is positioned below the fixed mirror 50 with a gap therebetween. A high reflective optical film 104 and an anti-reflective optical film 106 are coated on a top surface and a bottom surface of the suspended membrane 10 of the bidirectionally vertical motion actuator 1, respectively. It is also possible to bond the fixed mirror 50 on bidirectionally vertical motion actuator 1 with a spacer, which has a proper height, so as to control the small gap. Typically, the height of the spacer ranges from 5 to 20 microns so as to achieve the tunable filtering function for the selected spectrum.

When the vertical movement of the suspended membrane 10 changes the gap between the high reflective optical films 104 and 504, the optical path difference of the light entering the high reflective optical films 104 and 504 will be changed to achieve the object of phase modulation such that the property of the output light is modulated into a narrowband. In addition, when the gap between the high reflective optical films 104 and 504 is reduced to the micron level, the free spectral range (FSR) of the FP interferometer is enlarged. In this case, the function of the device is equivalent to that of the optical spectrum analyzer such as grating. So, the optical phase modulator 5 may serve as a tunable filter. Consequently, if the bidirectionally vertical motion actuator 1 of the invention is a single device, it may be applied to various interferometer systems; and if the actuator 1 is an array, it may be applied to the controlling of the light intensity or a spatial light modulator to replace the traditional piezoelectric actuator or other actuator.

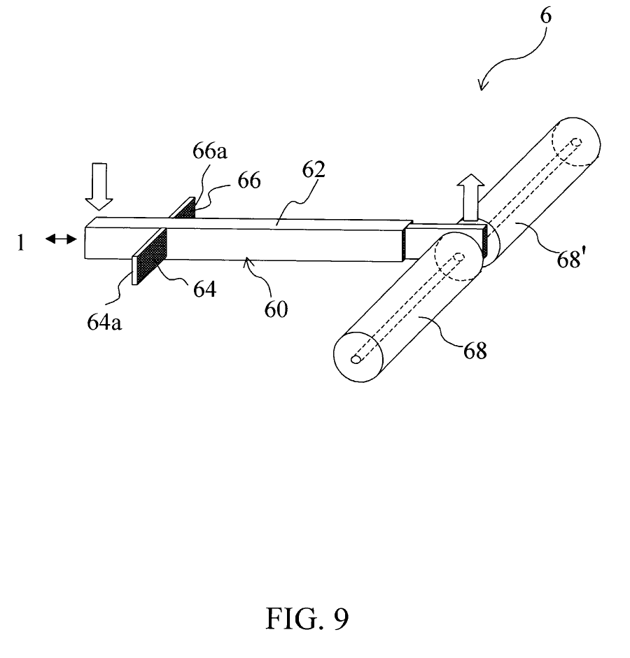

In addition to the above-mentioned optical phase modulator 5, the bidirectionally vertical motion actuator 1 of the invention may be combined with a lever to serve as a light intensity controller, such as a variable optical attenuator or an optical switch. Referring to FIG. 9, a light intensity controller 6 includes a lever 60 having a long arm 62 and torsional beams 64 and 66 opposite to each other at two sides of the long arm 62. The torsional beams 64 and 66 are fixed to the same substrate (not shown) as the actuator 1 via fulcrums 64a and 66a thereof, respectively The front end of the long arm 62 is connected to any middle point of the boundary of the suspended membrane 10 of the bidirectionally vertical motion actuator 1, and the rear end of the long arm 62 is located between two adjacent optical fibers 68 and 68′. When the suspended membrane 10 of the bidirectionally vertical motion actuator 1 moves in a direction as indicated by the arrow, the rear end of the long arm 62 moves upwards so as to change the light-shielding area between the adjacent optical fibers 68 and 68′ and to control the light intensity accordingly. Hence, the light intensity may be controlled in an analog manner corresponding to an attenuator. Alternatively, it is possible to achieve the object of controlling the light intensity in a digital manner corresponding to an optical switch. The moving displacement of the rear end of the long arm 62 is determined by the positions of the torsional beams 64 and 66 on the axis of the long arm 62, and the moving displacement of the rear end of the long arm 62 is usually between 5 and 50 microns.

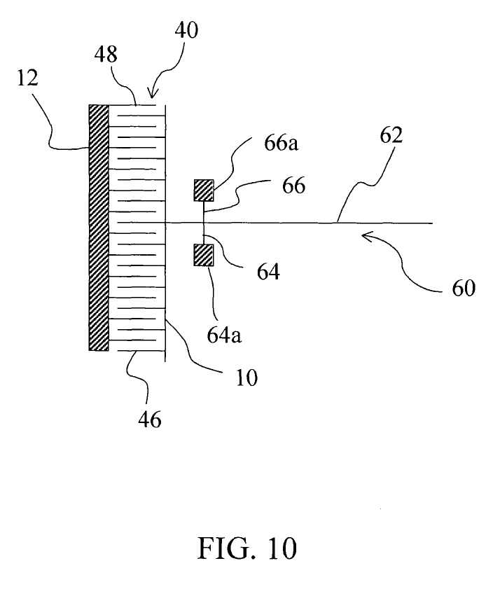

In order to further reduce the operation voltage of the applications of the variable optical attenuator and the optical switch of FIG. 9, the invention also provides another application embodiment, in which the bidirectionally vertical motion actuator 1 of FIG. 9 is modified into a vertical comb drive actuator 40, as shown in FIG. 10. The suspended membrane 10 of the vertical comb drive actuator 40 has a suspended interdigital electrode 46 extending outwardly and the fixed electrode structure 12 is also formed with extended, fixed interdigital electrodes 48, and the fixed electrode structure 12 and the suspended membrane 10 in this embodiment have symmetrical and flat comb shapes. So, the bidirectionally vertical reaction forces between the suspended and fixed interdigital electrodes 46 and 48 enable the long arm 62 to rotate up and down about the torsional beams 64 and 66 serving as rotating axes, thereby achieving the function of light attenuation and switch control.

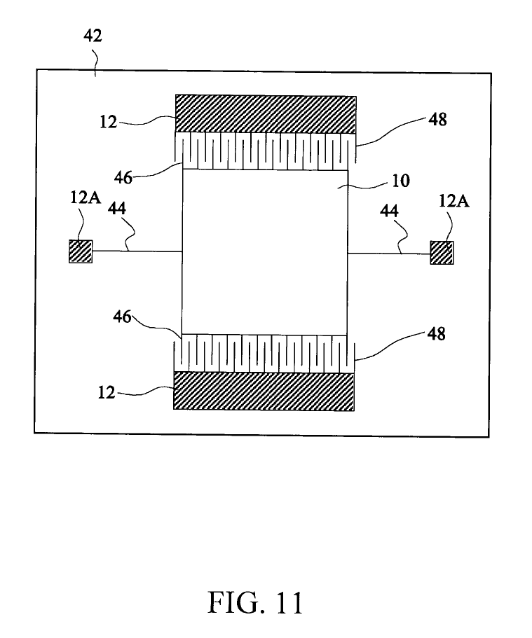

FIG. 11 shows a schematic illustration of one application of the bidirectionally vertical motion actuator of the invention to a torsion mirror. As shown in FIG. 11, the torsion mirror is also referred to as a scanning mirror, which includes a substrate 42, a fixed electrode structure 12, a suspended mirror membrane 10 and two supporting beams 44. The fixed electrode structure 12 is fixed to the substrate 4 and is formed with a set of fixed interdigital electrodes 48 and two supports 12A apart from the fixed interdigital electrodes 48. The suspended mirror membrane 10 may reflect light rays and is located above the substrate 4 and surrounded by the fixed electrode structure 12. That is, the suspended mirror membrane 10 is located at a space defined by several segments of the fixed electrode structure 12, as shown in FIG. 11. The suspended mirror membrane 10 is formed with a set of suspended interdigital electrodes 46 staggered with the fixed interdigital electrodes 48. The two supporting beams 44 connect the supports 12A of the fixed electrode structure 12 to the suspended mirror membrane 10, respectively, to support the suspended mirror membrane 10 above the substrate 42 and enable the suspended mirror membrane 10 to rotate about the two supporting beams 44. The above-mentioned operations for the fixed interdigital electrodes 48 and the suspended interdigital electrodes 46 may enable the suspended mirror membrane 10 to rotate about the two supporting beams 44 and achieve the effect of the torsion mirror.

In this embodiment, the suspended mirror membrane 10 is rectangular and the suspended interdigital electrodes 48 are formed at two sides of the suspended mirror membrane 10.

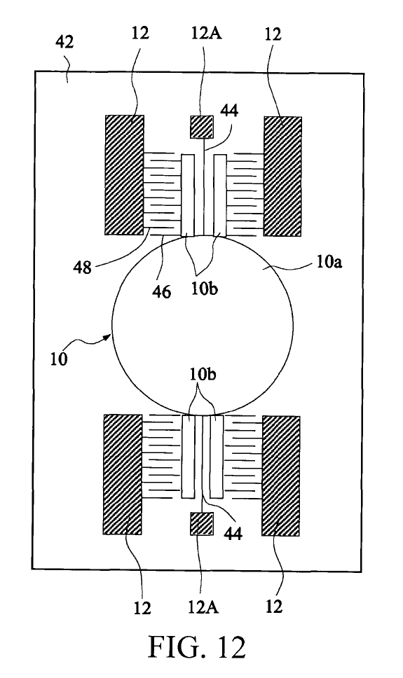

FIG. 12 shows a schematic illustration of another application of the bidirectionally vertical motion actuator of the invention to a torsion mirror. The torsion mirror of FIG. 12 is similar to that of FIG. 11 except for the following descriptions. The suspended mirror membrane 10 includes a circular mirror 10a and four extensions 10b connected to the circular mirror 10a. Each supporting beam 44 is located between two adjacent extensions 10b, and the suspended interdigital electrodes 46 is formed on the extensions 10b to achieve the effect of the torsion mirror.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A bidirectionally vertical motion actuator, comprising:
a substrate;
a floating structure located above the substrate and comprising a suspended membrane and at least one supporting beam extending outwardly from a boundary of the suspended membrane in a direction substantially parallel to the suspended membrane; and
at least one fixed electrode structure, which is insulated from the floating structure, formed on a lateral side of the floating structure, and fixed onto the substrate.

2. The bidirectionally vertical motion actuator according to claim 1, wherein the floating structure and the at least one fixed electrode structure have the same material and structure.

3. The bidirectionally vertical motion actuator according to claim 1, wherein each of the floating structure and the at least one fixed electrode structure comprises a first conductive layer, a dielectric layer on a top surface of the first conductive layer, and a second conductive layer on a top surface of the dielectric layer, and the first conductive layer of the at least one fixed electrode structure is located on a top surface of the substrate.

4. The bidirectionally vertical motion actuator according to claim 1, wherein the floating structure has four corners, each of which is supported and suspended above the substrate by a pair of supporting beams perpendicular to each other.

5. The bidirectionally vertical motion actuator according to claim 1, wherein the at least one fixed electrode structure is arranged around the floating structure.

6. The bidirectionally vertical motion actuator according to claim 1, wherein the floating structure is formed with at least one slit on its surface.

7. The bidirectionally vertical motion actuator according to claim 1, wherein the floating structure is coated with a high reflective film on its top surface.

8. The bidirectionally vertical motion actuator according to claim 7, wherein the high reflective film is selected from one of a group consisting of a metal film and a dielectric film.

9. A vertical comb drive actuator that may move bidirectionally, comprising:
a substrate;
a floating structure located above the substrate and comprising a suspended membrane and at least one supporting beam extending outwardly from a boundary of the suspended membrane in a direction substantially parallel to the suspended membrane, and at least one suspended interdigital electrode extending outwardly from a lateral side of the floating structure being formed; and
at least one fixed electrode structure, which is insulated from the floating structure, formed on a lateral side of the floating structure, and fixed onto the substrate, the at least one fixed electrode structure being formed with at least one fixed interdigital electrode staggered with the at least one suspended interdigital electrode at a lateral side facing the floating structure.

10. The vertical comb drive actuator according to claim 9, wherein the floating structure and the at least one fixed electrode structure have the same material and structure.

11. The vertical comb drive actuator according to claim 9, wherein each of the floating structure and at least one fixed electrode structure comprises a first conductive layer, a dielectric layer on a top surface of the first conductive layer, and a second conductive layer on a top surface of the dielectric layer.

12. The vertical comb drive actuator according to claim 9, wherein the floating structure has four corners, each of which is supported and suspended above the substrate by a pair of supporting beams perpendicular to each other.

13. The vertical comb drive actuator according to claim 9, wherein the at least one fixed electrode structure is arranged around the floating structure.

14. The vertical comb drive actuator according to claim 9, wherein the at least one suspended interdigital electrode and the at least one fixed interdigital electrode are vertically overlapped and staggered to form a vertical comb drive electrode structure.

15. The vertical comb drive actuator according to claim 9, wherein the floating structure is formed with at least one slit on its surface.

16. The vertical comb drive actuator according to claim 9, wherein the floating structure is coated with a high reflective film on its top surface.

17. The vertical comb drive actuator according to claim 16, wherein the high reflective film is selected from one of a group consisting of a metal film and a dielectric film.

18. A method for manufacturing a bidirectionally vertical motion actuator, comprising the steps of:
(a) providing a silicon-on-insulator (SOI) wafer, which comprises a first silicon wafer, an insulation layer on a top surface of the first silicon wafer, and a second silicon wafer;
(b) forming a dielectric layer on the SOI wafer by way of deposition;
(c) depositing a conductive layer on the dielectric layer;
(d) etching the conductive layer, the dielectric layer and the second silicon wafer simultaneously to form a proper trench; and
(e) forming an anisotropic etching groove on a backside of the SOI wafer.

19. The method according to claim 18, wherein the first silicon wafer is a handle silicon wafer.

20. The method according to claim 18, wherein the second silicon wafer is a good conductor with low resistivity.

21. The method according to claim 18, wherein the insulation layer is a silicon oxide layer.

22. The method according to claim 18, wherein the step (d) is performed by way of deep silicon etching.

23. The method according to claim 18, wherein the top trench formed in the step (d) is selected from one of a group consisting of a ring-shaped trench, a rectangular ring-shaped trench, and a line-shaped trench.

24. The method according to claim 18, wherein the top trench formed in the step (d) vertically penetrates through the conductive layer, the dielectric layer and the second silicon wafer.

25. The method according to claim 18, wherein the anisotropic backside etching groove penetrates through the first silicon wafer and the insulation layer.

26. The method according to claim 18, wherein the anisotropic etching groove communicates with the top trench.

27. An optical phase modulator, comprising:
a fixed mirror having a top surface coated with an anti-reflective optical film, and a bottom surface coated with a high reflective optical film;
a bidirectionally vertical motion actuator located below the fixed mirror with a gap therebetween, the bidirectionally vertical motion actuator comprising a substrate, a floating structure fixed above the substrate, and at least one fixed electrode structure fixed onto the substrate and located on a lateral side of the floating structure;
a high reflective optical film arranged on a top surface of the floating structure; and
an anti-reflective optical film arranged on a bottom surface of the floating structure.

28. The optical phase modulator according to claim 27, wherein the fixed mirror and the bidirectionally vertical motion actuator are bonded together with a spacer therebetween.

29. A light intensity controller, comprising:
a lever;
two torsional beams, which are respectively mounted to two sides of the lever and opposite to each other, the torsional beams serving as fulcrums fixed to a substrate; and
a bidirectionally vertical motion actuator connected to a front end of the lever.

30. The light intensity controller according to claim 29, wherein a rear end of the lever is located between two adjacent optical fibers.

31. The light intensity controller according to claim 29, wherein when the actuator moves down, a rear end of the lever moves upwards to change light-shielding area between two optical fibers and to control light intensity accordingly.

32. The light intensity controller according to claim 31, wherein a displacement of the rear end of the lever is determined by positions of the torsional beams on an axial direction of the lever.

33. The light intensity controller according to claim 29, wherein the bidirectionally vertical motion actuator comprises:
the substrate;
a floating structure located above the substrate and including a suspended membrane and at least one supporting beam extending outwardly from a boundary of the floating structure in a direction substantially parallel to the suspended membrane; and
at least one fixed electrode structure mounted to a lateral side of the floating structure and insulated from the floating structure, the at least one fixed electrode structure being fixed to the substrate.

34. The light intensity controller according to claim 29, wherein the bidirectionally vertical motion actuator is a vertical comb drive actuator that may move bidirectionally.

35. The light intensity controller according to claim 34, wherein the vertical comb drive actuator comprises:
the substrate;
a floating structure located above the substrate and comprising a suspended membrane and at least one supporting beam extending outwardly from a boundary of the suspended membrane in a direction substantially parallel to the suspended membrane, and at least one suspended interdigital electrode extending outwardly from a lateral side of the floating structure being formed; and
at least one fixed electrode structure, which is insulated from the floating structure, formed on a lateral side of the floating structure, and fixed onto the substrate, the at least one fixed electrode structure being formed with at least one fixed interdigital electrode staggered with the at least one suspended interdigital electrode at a lateral side facing the floating structure.

36. A torsion mirror, comprising:
a substrate:
a fixed electrode structure fixed to the substrate and formed with a set of fixed interdigital electrodes and two supports apart from the fixed interdigital electrodes;
a suspended mirror membrane located above the substrate and surrounded by the fixed electrode structure, the suspended mirror membrane being formed with a set of suspended interdigital electrodes staggered with the fixed interdigital electrodes; and
two supporting beams, which connects the supports of the fixed electrode structure to the suspended mirror membrane, respectively, for supporting the suspended mirror membrane above the substrate and enabling the suspended mirror membrane to rotate about the two supporting beams.

37. The torsion mirror according to claim 36, wherein the suspended mirror membrane is rectangular and the suspended interdigital electrodes are formed on a lateral side of the suspended mirror membrane.

38. The torsion mirror according to claim 36, wherein the suspended mirror membrane comprises:
a circular mirror; and
four extensions connected to the circular mirror, wherein each of the supporting beams is located between two adjacent extensions and the suspended interdigital electrodes are formed on the extensions.
